(19) United States
(12) Patent Application Publication
(10) Pub. No.: US 2014/0125286 A1
(43) Pub. Date: May 8, 2014

(54) METHOD FOR CONTROLLING THE CHARGING OF SEGMENTS FOR AN ONLINE ELECTRIC VEHICLE

(71) Applicant: Korea Advanced Institute of Science and Technology, Daejeon (KR)

(72) Inventors: Dong Ho Cho, Seoul (KR); Bang Chul Jung, Seoul (KR); Woo Hyuk Chang, Gyeongsan (KR); Jong Min Lee, Daejeon (KR); Jin Kyu Kim, Daejeon (KR); Young Min Kim, Daejeon (KR); Hyun Woo Chun, Daejeon (KR); Mi Hyun Park, Daejeon (KR)

(73) Assignee: Korea Advanced Institute of Science and Technology, Daejeon (KR)

(21) Appl. No.: 13/892,136

(22) Filed: May 10, 2013

Related U.S. Application Data
(60) Provisional application No. 61/646,467, filed on May 14, 2012.

(51) Int. Cl. B60L 11/18

(52) U.S. Cl. CPC B60L 11/182
USPC 320/128

(57) ABSTRACT

A method for controlling the charging of segments for an online electric vehicle is described. In some situations, the method comprises: (a) receiving, from segments, information on the speed and position of the vehicle entering the range of the power-supplying device; and (b) controlling the charging/discharging timing of the current segment from which the vehicle is leaving and the next segment into the range of which the vehicle is to enter, in accordance with the information on the speed and position of the vehicle. The charging/discharging response delay characteristics of the segments may be considered.

### RELATED APPLICATIONS

This Application claims priority under 35 U.S.C. §119(e) to U.S. Provisional Application Ser. No. 61/646,467, filed May 14, 2012 under Attorney Docket No. O0333.70013US00 and entitled “METHOD FOR CONTROLLING THE CHARGING OF SEGMENTS FOR AN ONLINE ELECTRIC VEHICLE”, which is hereby incorporated herein by reference in its entirety.

### BACKGROUND

The present application relates to a method for controlling the charging of segments for an online electric vehicle.

Amidst environmental issues such as the emission of fossil fuels, energy improvements are underway with regard to the standard vehicle. However, it is difficult to travel long distances due to the limited battery capacity of battery modules that are mounted on electric vehicles. Also, another weakness is the waiting time required while the battery is charged via connection to a power-supplying device. Not only this, but the distance that can be traveled on a single charge is restrictive.

### BRIEF SUMMARY

Some embodiments of the present application relate to a method for controlling the charging of segments for an online electric vehicle, which controls an inverter with due consideration for the charging response time of segments so as to reduce the waste of electricity in a system that supplies electricity to the electric vehicle through magnetic induction using a power-supplying device including one or more segments buried under a road surface

To overcome some of the weaknesses of conventional electrical vehicles, improvements were made to expand battery capacity, as well as to improve the efficiency of charging systems. However certain issues arose including increased vehicle weight, decreased efficiency; increase vehicle units costs, and reduction in the life cycle of the battery.

Accordingly, aspects of the present application provide an improved vehicle model mounted with a strategic battery module, along with the installation of a power source buried under a road surface, wherein the battery of an online electric vehicle is charged through magnetic induction. Such a vehicle, powered by magnetic induction has the advantage of being driven by the power of a mounted battery in cases where the power-supplying device is cut off.

In the initial phase with regard to a charged device, either the laying of an expandable power-supplying device under a road surface, or the laying a power-supplying design en bloc may be performed, given that fixed units for the module in segments facilitate recent changes.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 depicts an outline of an embodiment of a method and system for charging segments buried under a road surface that supply power to an online electric vehicle.

FIG. 2 further illustrates the operation of the system of FIG. 1.

FIG. 3 is a graph related to voltage gap, in accordance with the discharging/charging response time in the embodiment of FIG. 1.

FIG. 4 depicts the charging method of segments in accordance with the embodiment of FIG. 1.

FIG. 5 illustrates the device and method for controlling the charging of segments for an electric vehicle according to an alternative embodiment to that of FIG. 1.

FIG. 6 is a graph related to the voltage gap, in accordance with the passage of time, in accordance with the embodiment of FIG. 5.

FIG. 7 depicts the charging method of segments in accordance with the embodiment of FIG. 5.

FIG. 8 illustrates a method and device for controlling the charging of segments for an electric vehicle in accordance with another embodiment of the present application.

### DETAILED DESCRIPTION

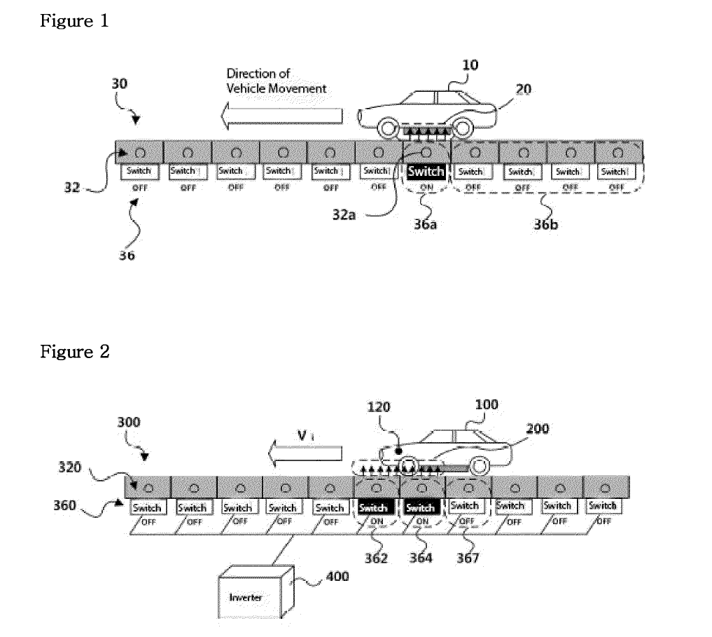

FIG. 1 depicts the outline of a power supply system inclusive of the voltage current collector of a standard online electric vehicle, and the device which includes power-supplying segments buried under a road surface that power the electric vehicle.

First, with regard to the current collector of a standard online electric vehicle, as depicted, the electric vehicle (10) is situated centrally over the buried segments that are approximately ⅓ the length of the car and have a square shape. Also, the power-supplying device is comprised of one or more power segments (30) that trigger a magnetic field by way of unit modules, the vehicle sensor (32) located above the power segments (30) that detects an entering vehicle, the power segments (30) that transmit power supplied from the source, and also the switch (36) that cuts off power.

The method for supplying power for a standard online electric vehicle occurs in succession when the vehicle sensor (32a) of the power segment (36a) detects an electric vehicle (10) and as the switch is connected, a magnetic field (20) is produced wherein the electric vehicle (10) receives a power supply. As such an electric vehicle (10) goes through each of the power segments (36b) the associated switch will turn to the ‘ON’ state when the vehicle above enters a segment, and power is then supplied to the electric vehicle (10), and when leaving the power segment, is turned to the ‘OFF’ state wherein the power supply is cut off. At this time, since the power segment of the switch, triggered by the vehicle sensor is turned to ‘ON’ or ‘OFF’ in accordance with the time when the vehicle is entering, the response time will have a time delay in line with the hardware characteristics. The time delay to such response time arises from the characteristics of the charging/discharging capacitor inside the power-supplying inverter, the internal switch means, vehicle sensor error, and time required to receive and process the inverter ON/OFF control signal, etc. An example of this is if the switch inside an inverter is an electronic switch, a few tens of microseconds of time is required, but in the case of a mechanical switch, a few hundred milliseconds of time is required. Supposing the case where a mechanical switch is utilized, approximately two seconds are needed in order to reach 100% voltage from the time from when the power segment is ‘ON’, and when turned ‘OFF’ approximately one second is needed until discharging is complete.

In other words, inefficiency arises due to the delay in charging/discharging response time, in accordance with the power segment length and vehicle movement speed. The efficiency is reduced after the vehicle enters and the segment is turned to the ‘ON’ state since the voltage may not reach 100% before the vehicle passes through, and there is the issue of energy loss that arises when the state of the segment is turned to ‘OFF’ after a vehicle advances.

Aspects of the present application improve efficiency and prevent waste of electricity in accordance with the charging/discharging response delay of the segment-model online electric vehicle.

### First Embodiment

According to the preferred embodiment of the present application, the method for controlling the charging operation of segments for an online electric vehicle comprises: (a) receiving, from segments, information on the speed and position of the vehicle entering the range of the power-supplying device; and (b) controlling the charging/discharging timing of the current segment from which the vehicle is leaving and the next segment into the range of which the vehicle is to enter, in accordance with the information on the speed and position of the vehicle.

Step (b) may comprise (b1) discharging of the segment from which the vehicle is leaving before it has completely advanced, in accordance with the segment discharging response time; and (b2) charging of the segment to which the vehicle is entering, before it has completely advanced, in accordance with the segment charging response time.

The method for controlling the charging operation of segments for multiple online electric vehicles may comprise: (a) The step of commencing charging of the nth (where N is a natural number or integer) segment to which the lead vehicle will enter, among multiple vehicles; (b) receiving, from the N−1th segment, information on the speed and position of the following vehicle; (c) receiving, from the nth segment, the discharging request, in accordance with when the lead vehicle leaves; and (d) Determining whether or not to discharge the nth segment in accordance with information on the speed and position of the lead and following vehicles.

Preceding step (a) in the above-described method, the method may comprise: receiving, from the N+1th segment, information on the speed and position of the lead vehicle; and charging the nth segment, in accordance with the information on the speed and position.

Following step (d), the method may comprise (d1) the step, wherein if it is determined that the following vehicle will enter before the discharging of the Nth segment is complete, the charging state of the Nth segment is maintained; and/or, (d2) the step, wherein if it is determined that the following vehicle will enter after the discharging of the Nth segment is complete, the Nth segment will be discharged.

Following step (d2) the method may include charging the segment into the range of which the following vehicle is to enter, in accordance of the charging response time of the nth segment.

The method for controlling the charging operation of segments for a group of online electric vehicles may comprise: (a) Designating the very first vehicle as the header vehicle, among a group of vehicles; (b) Beginning charging of the nth (where n is a natural number or integer) segment into the range of which the header vehicle is to enter; (c) receiving, from the n−1th segment, information on the speed and position of the vehicle following the header vehicle, among a group of vehicles; (d) receiving, from the nth segment, a discharging request, in accordance with when the header vehicle leaves; and (e) Determining whether or not to discharge the nth segment in accordance with information on the speed and position of the header and following vehicles.

A group of vehicles is determined to exist in accordance with the information of the recorded gap between each vehicle, vehicle ID and/or the movement speed of each vehicle.

Preceding step (a), the method may comprise: receiving from the n+1th segment information on the speed and position of the header vehicle; and charging the nth segment, in accordance with the speed and position.

With regard to step (e), the method may include: (e1)) the step, wherein if it is determined that the following vehicle will enter before the discharging of the Nth segment is complete, the charging state of the Nth segment is maintained; and/or, (e2) the step, wherein if it is determined that the following vehicle will enter after the discharging of the Nth segment is complete, the Nth segment will be discharged.

### Efficiency

The preferred embodiment of the present application controls the operation of segments of the power-supplying device in accordance with the travel speed of the online electric vehicle with due consideration for the charging/discharging response delay characteristics of the segments, thereby improving efficiency and preventing a waste of electricity,

By referring to the figures in accordance with the preferred embodiment of the present application, the device and method for controlling the charging of segments for an online electric vehicle is explained further. The illustrated components and methods represent non-limiting example, as various modifications are possible and within the scope of the aspects of the present application.

Three modes are now described: (Mode 1) the case of the preferred embodiment where a single vehicle is in operation; (Mode 2) the case where multiple vehicles are operated in a series; and (Mode 3) the case where a group formation of many vehicles are operated.

Mode 1: The case where one vehicle is operated independently

FIG. 2 is included in order to explain preferred embodiment #1 of the device and method for controlling the charging of segments for an online electric vehicle.

As depicted, if a single electric vehicle (100) is operated over a road where a power-supplying device is buried under a road, at a speed of vi, power is supplied due to a magnetic field that is produced when the switch (360) of the power-supplying device is connected.

At this point, the electric vehicle (100) is comprised of a power segment, and an associated transmitter-receiver that transmits information. The information transmitter-receiver (120) sends information such as the segment ID which supplies power to the vehicle, ‘ON/OFF’ state information, vehicle ID received from the vehicle, vehicle speed information, etc. A vehicle sensor 320 is included in the road. The power segment (300), as it receives strategic information from the transmitter-receiver (120), supplies the power-supply controlling inverter (400), and in accordance with the information supplied by the inverter (400), the switch(es) of the range into which the present vehicle is entering (364) and the segment range to which the vehicle is expected to later enter (362) receive the ‘ON’ command such that a magnetic field 200 is generated; and likewise, the switch on the current segment (367) from which the present vehicle is leaving, receives the ‘OFF’ command.

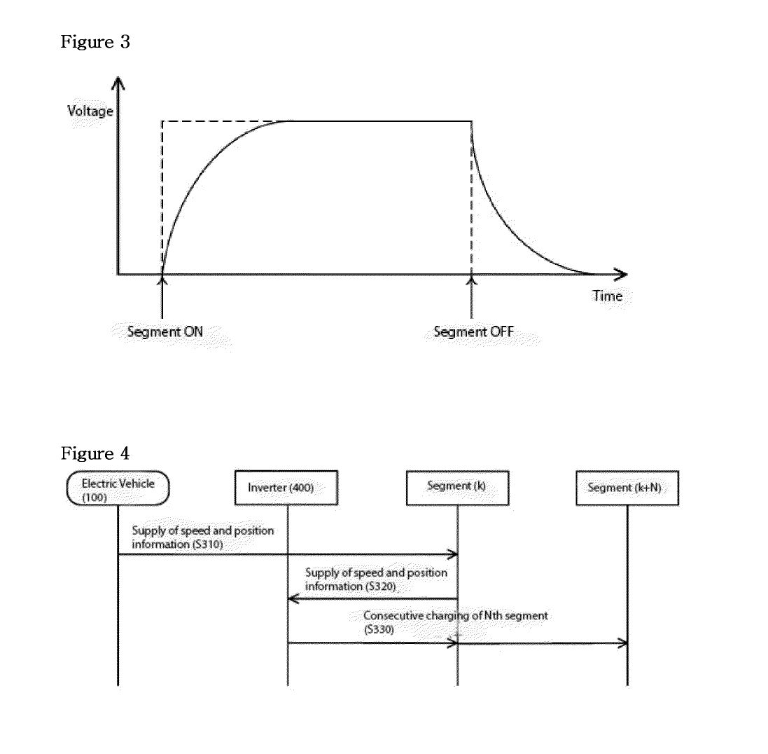

This kind of power-supplying segment does not only control the strategic vehicle speed (vi), but also determines the discharging/charging response time of the segment. The strategic discharging/charging response time is resolved as the time after which the inverter receives the ‘ON’ command and the segment reaches 100% voltage, and, the time after which the inverter receives the ‘OFF’ command and the segment voltage falls to 0%. The charging/discharging time, in accordance with the resolution time, is outlined on the related FIG. 3 which shows the gap in the voltage period. Accordingly, the next segment needs to be charged in advance, if the next segment range into which the vehicle is to enter is to reach 100% voltage.

FIG. 4 depicts Preferred Embodiment #1 of the segment charging method. Accordingly, segment {k(where k is a natural number or integer)} receives the information on the speed and position (S310), and the vehicle ID, from the electric vehicle (100); and the information received from the kth segment (S320) is supplied to the inverter (400). Subsequently (S330), the inverter (400) controls the charging of the nth (k+N) segment, in accordance with transmitted information.

### Mode 2: Multiple Vehicles Operated in a Series

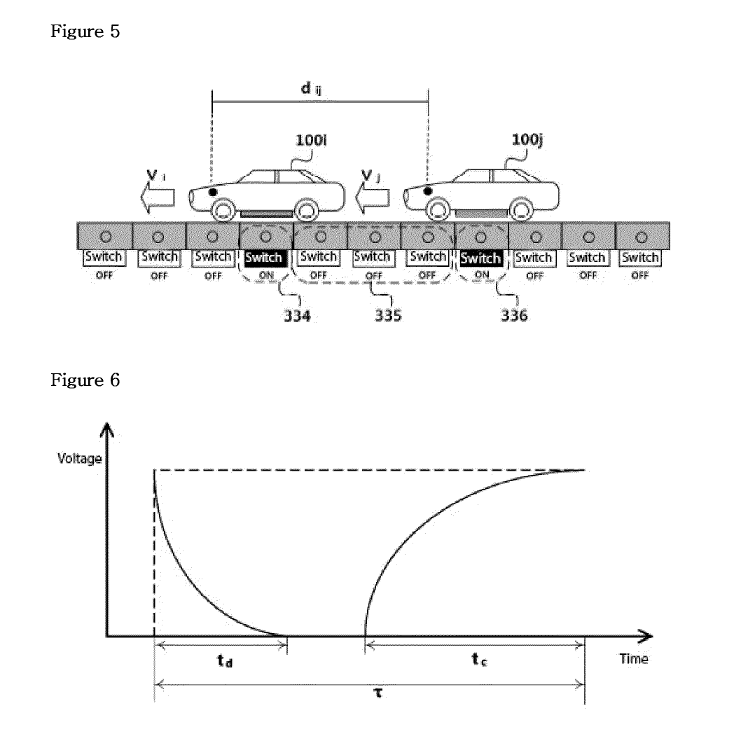

FIG. 5 explains another embodiment of the application of the device and method for controlling the charging of segments for an online electric vehicle.

As depicted, multiple electric vehicles (100i, 100j) are operated over a road where a power-supplying device is buried under a road, at a speed of vi, when power is supplied due to a magnetic field that is produced when the switch of the power-supplying device is connected (334, 336).

At this time, as two vehicles pass through a segment, the control is executed not only by the vehicle speed and discharging/charging response time, but also as the gap between vehicles dij is considered. More specifically, and in accordance with the entrance of the current lead vehicle (100i), the power-supplying segment has the effect of being in the ‘ON’ state, since the following vehicle (100j) is to continually advance, the ‘ON’ state is maintained even after the lead vehicle (100i) leaves the segment range. In such cases, the switch (335) in the middle is similarly applied. The strategic consecutive passage time, refers to the delay that exists, as the electric vehicle advances, from the time that the segment charging the lead vehicle receives the ‘OFF’ command, and the time that the consecutive following car enters the segment range. This large gap of voltage is depicted on a related graph with the accordance consecutive passage time in FIG. 6.

Referring to FIG. 6, (td) denotes the discharging response time from when the lead vehicle leaves the segment range until discharging is complete; and, (tc) denotes the charging response time from after the fixed time the following car enters the segment range, and, the consecutive passing time (T) denotes the time after discharging until charging is again complete. In other words, if the consecutive passing time (T) is less than discharging/charging response time (tc+td) then the following vehicle advances prior to the time that discharging of the segment is complete, and thus the segment is maintained in the ‘ON’ state. Conversely, if the consecutive passing time (T) is greater than the discharging/charging response time (tc+td) then the following vehicle advances after the time the discharging of the segment is complete, and thus the segment is turned to the ‘OFF’ state, afterwards, a fixed time (t−tc), the segment has the effect of again turning to the ‘ON’ state.

Furthermore, in referring to FIG. 5 again, the inverter controls the ON/OFF state of each segments from a time t such that, when the vehicle passes through by speed vi, the ON/OFF state is controlled according to t+T, depending on the gap between the following and lead vehicles dij. At this point, Equation 1 below is satisfied, in cases where the speed of movement for each vehicle is a constant velocity.

$${d}_{ij} ( t ) = {v}_{j} ( t ) τ , \\ τ = \frac{{d}_{ij} ( t )}{{v}_{j} ( t )} \qquad Equation 1$$

Also, Equation 2 below is satisfied, in cases where the speed of movement for the vehicle is an equivalent velocity.

$${d}_{ij} = {v}_{j} ( t ) τ + 0.5 a {τ}^{2} , \\ τ = \frac{- {v}_{j} ( t ) + \sqrt{{{v}_{j} ( t )}^{2} + 2 a}}{a} ( Units , T > 0 ) \qquad Equation 2$$

Furthermore, the inverter will continue to maintain the segment in ‘ON’ state if the value of T is less than the value of tc+td, and, if the value of T is greater than value of tc+td, after changing the segment to the ‘OFF’ state, once the following vehicle enters, the segment is again turned to the ‘ON’ state.

In other words, the inverter, in accordance with the departure of the lead vehicle, operates such that, if it is determined that the following vehicle will enter before the discharging of the Nth segment is complete, the charging state of the Nth segment is maintained; and/or, if it is determined that the following vehicle will enter after the discharging of the Nth segment is complete, the discharging of segment (334) begins. Subsequently, the segment (335) in the segment range that the vehicle will enter is charged while segment (336) from which the vehicle departs is discharged, in accordance with the segment charging response time.

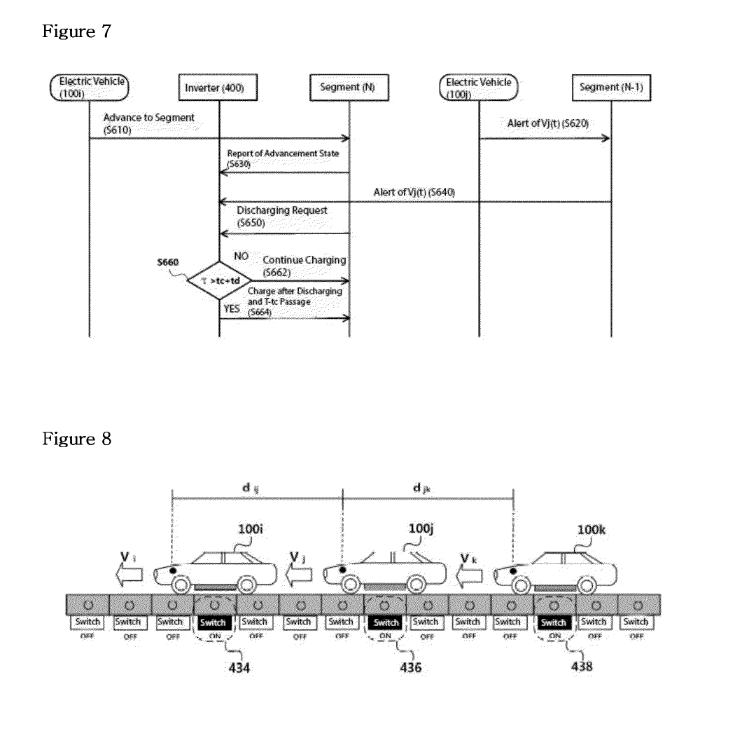

FIG. 7 depicts preferred embodiment #2 of the segment charging method. In this embodiment, first the lead vehicle (100i) advances to the nth segment (S610). If the transmission of information on the speed ((vj(t)) from following vehicles is received by the n−1th segment (S620) the nth segment reports to the inverter (400) the fact that the lead vehicle (100i) is advancing (S630), and, the n−1th segment reports (S640) to the inverter (400) the information on speed (Vj(t)). Moreover, when the Nth segment sends a discharging request (S650) to the inverter (400), the inverter (400) compares the value of T and tc+td (S660), and if T is less than tc+td, the segment maintains the ‘ON’ state (S662). If the value of T is greater than tc+td, after the segment is turned to the ‘OFF’ state, it is turned ‘ON’ again if the following vehicle advances (S664).

### Mode 3: Operation of a Group Formation of Many Vehicles

FIG. 8 explains preferred embodiment #3 of the device and method for controlling the charging of segments for an online electric vehicle.

As depicted, a group formation of many vehicles (100i, 100j, 100k) are separated by intervals dij and djk and travel at respective speeds of Vi, Vj, Vk. Power is supplied to the vehicles via a magnetic field to each vehicle through the power segments (434, 436, 438), which may be buried power segments in or under the road.

At this point, in accordance with information that is registered prior to operation, each vehicle from a group formation of many vehicles and each vehicle ID from the central control system that is connected with the inverter, along with information on the speed, etc., can determine whether there is a group formation or not. In such cases where a group formation of many vehicles are operated, the lead vehicle in the group is set-up as the header vehicle, and both the header vehicle and those vehicles following the header vehicle are controlled similarly by the power segments. In other words, the timing of charging is controlled in accordance with the segment range that the header vehicle is to pass through (434), and, the segment range that the following vehicle will pass through (436), and afterwards similarly for segment (438).

In such cases where the group formation of vehicles has an equivalent speed {vi(t)=vj(t)=vk(t)} and an equivalent interval distance {dij(t)}, then the equivalent speed is satisfied in Equation 3.

$${d}_{ij} ( t ) = {v}_{j} τ , \\ τ = \frac{{d}_{ij} ( t )}{{v}_{j} ( t )} \qquad Equation 3$$

Also, in such cases where the movement speed is of equivalent velocity, Equation 4 below is satisfied.

$${d}_{ij} ( t ) = {v}_{j} ( t ) τ + 0.5 a {τ}^{2} , \\ τ = \frac{- {v}_{j} ( t ) + \sqrt{{{v}_{j} ( t )}^{2} + 2 a}}{a} ( Units \text{:} T > 0 ) \qquad Equation 4$$

Accordingly, if the value of T is less than the value of tc+td, the inverter will maintain the segment in the ‘ON’ state, and if value of T is greater than value of tc+td, it will turn the segment to ‘OFF’ state and, afterwards, the segment range to which the following vehicle will advance is charged before it enters. Other than the speed of the header vehicle being the standard in accordance with this preferred embodiment #3, the charging method response also responds in accordance with the operation previously described in connection with preferred embodiment #2.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described.

1. A method for controlling the charging of segments for an online electric vehicle, comprising:
(a) receiving information, from segments, regarding the speed and position of an entering vehicle; and,
(b) controlling the charging/discharging timing of the current segment from which the vehicle is leaving and the next segment into the range of which the vehicle is to enter, in accordance with the information on the speed and position of the vehicle.

2. The method according to claim 1, wherein step (b) comprises:
(b1) discharging one segment before the vehicle has completely advanced, in accordance with the segment discharging response time; and
(b2) charging the next segment into the range which the vehicle is to enter, in accordance with the segment charging response time.

3. A method for controlling the charging of segments for a number of online electric vehicles comprising:
(a) charging the nth segment, where n is an integer, greater than one, in accordance with the entering of the lead vehicle, in the case where there are a number of vehicles;
(b) receiving information from the n−1th segment, regarding the speed and position of following vehicles;
(c) receiving discharging requests from the nth segment in accordance with the entering of the lead vehicle; and,
(d) approving or rejecting the discharging of the nth segment in accordance with the information on the speed and position of the lead and following vehicle.

4. The method of claim 3, wherein, preceding step (a), the method for controlling the charging of segments for an electric vehicle includes: receiving information from the n+1^{th} segment on the speed and position of the lead vehicle; and, charging the n^{th} segment in accordance with the information on such speed and position.

5. The method of claim 3 wherein step (d) comprises:
(d1) if it is determined that the following vehicle will enter before the discharging of the Nth segment is complete, the charging state of the Nth segment is maintained; and/or,
(d2) wherein if it is determined that the following vehicle will enter after the discharging of the Nth segment is complete, the Nth segment will be discharged.

6. The method of claim 5, wherein subsequent to step (d2) the method comprises charging the segment into range of which the following vehicle will enter is charged, in accordance with the N^{th} segment charging response time.

7. A method for controlling the charging of segments for an online electric vehicle, comprising:
(a) designating a lead vehicle as the header vehicle, among a group of vehicles;
(b) charging an Nth, where n is an integer greater than one, segment in accordance with the advancement of the header vehicle;
(c) receiving information from the N−1th segment regarding the speed and position of the vehicle following the header vehicle;
(d) receiving a discharging request from the Nth segment, in accordance with the advancement of the header vehicle; and
(e) approving or rejecting the discharging request in accordance with the information on the speed and position of the header vehicle and following vehicle.

8. The method of claim 7, wherein a group of vehicles is determined to exist in accordance with the information of the recorded gap between each vehicle, vehicle ID and/or the movement speed of each vehicle.

9. The method of claim 7, wherein prior to step (a) the method comprises receiving information from the N+1th segment, regarding the speed and position of the header vehicle, and charging the nth segment in accordance with information regarding such speed and position.

10. The method of claim 8, wherein step (e) comprises:
(e1) if it is determined that the following vehicle will enter before the discharging of the Nth segment is complete, maintain the charging state of the Nth segment; and/or,
(e2) if it is determined that the following vehicle will enter after the discharging of the Nth segment is complete, discharging the Nth segment.

11. The method of claim 10, wherein subsequent to step (e2) the method comprises charging of the segment which the following vehicle will enter, before it enters, in accordance with the charging response time of the nth segment.
